(19) United States
(12) Patent Application Publication
(10) Pub. No.: US 2010/0118196 A1
(43) Pub. Date: May 13, 2010

(54) METHOD AND APPARATUS FOR SCANNING CHANNEL IN DIGITAL BROADCAST RECEIVER

(75) Inventor: Dong-Sub Lee, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd.

(21) Appl. No.: 12/618,375

(22) Filed: Nov. 13, 2009

(30) Foreign Application Priority Data
Nov. 13, 2008 (KR) 10-2008-0112980

(51) Int. Cl. H04N 5/50

(52) U.S. Cl. 348/569; 348/732; 348/E05.097

(57) ABSTRACT

A method and an apparatus for scanning a channel in a digital broadcast receiver are provided. In the method, number of broadcast channels to be scanned are determined. Frequency values corresponding to the broadcast channels are determined. Thereafter, at least one broadcast channel is scanned based on the determined frequency values.

### PRIORITY

This application claims priority under 35 U.S.C. §119(a) to a Korean Patent Application filed in the Korean Intellectual Property Office on Nov. 13, 2008 and assigned Serial No. 10-2008-0112980, the content of which is incorporated herein by reference.

### BACKGROUND OF THE INVENTION

1. Field of the Invention

The present invention relates generally to channel scanning in a digital broadcast receiver, and more particularly, to a method and an apparatus for selecting a plurality of channels and scanning a channel in a digital broadcast receiver. Here, “scan” means the same thing that “search” means through the description of the invention.

2. Description of the Related Art

Digital broadcast services provide an image of up to four to five times higher definition than an existing analog broadcast service, and also provide various data information to a user in real-time. Additionally, the number of digital broadcast channels is increasing.

Consequently, with this increase in the number of digital channels, a method for accurately searching for a channel in a short time, when scanning a digital channel in a digital broadcast receiver is important.

More specifically, a digital broadcast receiver, such as a digital TeleVision (TV), a ground wave Digital Multimedia Broadcasting (DMB) and satellite DMB receiver, a Set-Top Box (STB), etc., performs automatic channel scanning or manual channel scanning and stores scanned channel information in an internal memory. Thereafter, when a user selects a broadcast channel, the digital broadcast receiver tunes to the selected broadcast channel with reference to the stored channel information stored.

However, automatic channel scanning takes a considerable amount of time because channel searching is performed over all frequencies. In addition, unnecessary channels are scanned. Additionally, manual channel scanning is inconvenient in that a user sets a frequency in a menu and then collects searching results for each frequency.

### SUMMARY OF THE INVENTION

The present invention addresses at least the above-described problems and/or disadvantages occurring in the prior art and provides at least the advantages as described below.

Accordingly, an aspect of the present invention is to provide a method and an apparatus for conveniently selecting a plurality of channels desired by a user and performing channel scanning in a digital broadcast receiver.

Another aspect of the present invention is to provide a method and an apparatus providing a reduced channel scanning time in a digital broadcast receiver.

In accordance with an aspect of the present invention, a method for scanning a channel in a digital broadcast receiver is provided. The method includes determining number of broadcast channels to be searched, determining frequency values corresponding to the broadcast channels, and searching the broadcast channel based on the determined frequency values.

In accordance with another aspect of the present invention, a method for scanning a channel in a digital broadcast receiver is provided. The method includes determining a frequency value corresponding to a broadcast channel to be searched, displaying the determined frequency values; querying a user whether to scan another broadcast channel, and searching the broadcast channel based on the determined frequency value.

In accordance with another aspect of the present invention, a method for scanning a channel in a digital broadcast receiver is provided. The method includes, when a multi-manual channel scan menu is selected, displaying a broadcast channel list, selecting a frequency corresponding to at least one broadcast channel to be searched from the displayed broadcast channel list, and searching for a frequency corresponding to the selected at least one broadcast channel.

In accordance with another aspect of the present invention, an apparatus for scanning a channel in a digital broadcast receiver is provided. The apparatus includes a scan setting unit for determining a number of broadcast channels to be searched, and determining frequency values corresponding to the broadcast channels; and a synchronizer for searching the broadcast channels based on the determined frequency values.

In accordance with another aspect of the present invention, an apparatus for scanning a channel in a digital broadcast receiver is provided. The apparatus includes a scan setting unit for determining at least one frequency to be searched, and displaying the determined frequency, and querying a user as to whether to scan another broadcast channel; and a synchronizer for searching for the frequency corresponding to the broadcast channel, when requested by the user.

In accordance with another aspect of the present invention, an apparatus for scanning a channel in a digital broadcast receiver is provided. The apparatus includes a controller for, when a multi-manual channel scan menu is selected, displaying a broadcast channel list, a scan setting unit for selecting at least one frequency to be searched from the displayed broadcast channel list, and a synchronizer for searching for a frequency corresponding to the selected at least one broadcast channel.

Other aspects, advantages, and salient features of the invention will become apparent to those skilled in the art from the following detailed description, which, taken in conjunction with the annexed drawings, discloses certain embodiments of the present invention.

### BRIEF DESCRIPTION OF THE DRAWINGS

The above and other aspects, features, and advantages of the present invention will be more apparent from the following description when taken in conjunction with the accompanying drawings in which:

FIG. 1 illustrates a flowchart for selecting a plurality of channels desired by a user and performing channel scanning by a digital broadcast receiver according to an embodiment of the present invention;

FIG. 2 illustrates a channel scan menu tree in a digital broadcast receiver according to an embodiment of the present invention; and

FIG. 3 illustrates a digital broadcast receiver for selecting a plurality of channels desired by a user and performing channel scanning, according to an embodiment of the present invention.

### DETAILED DESCRIPTION OF EMBODIMENTS OF THE INVENTION

Various embodiments of the present invention are described in detail below with reference to the accompanying drawings. In the drawings, the same or similar components may be designated by the same or similar reference numerals, although they may be illustrated in different drawings. Detailed descriptions of constructions or processes known in the art may be omitted to avoid obscuring the subject matter of the present invention. Terms described below, which are defined considering functions in the present invention, can be different depending on user and operator's intention or practice. Therefore, the terms should be defined on the basis of the disclosure throughout this specification.

The embodiments of the present invention, as will be described below, provide a method and an apparatus for selecting a plurality of channels desired by a user and performing channel scanning by a digital broadcast receiver. In the following description, the digital broadcast receiver may be a digital TV, a ground wave DMB and satellite DMB receiver, an STB, a Personal Video Recorder (PVR), a portable digital broadcast receiver, a digital broadcast receiver for a vehicle, etc.

Once again, hereunder, “scan” and “search” used through the description of the invention have the same meaning.

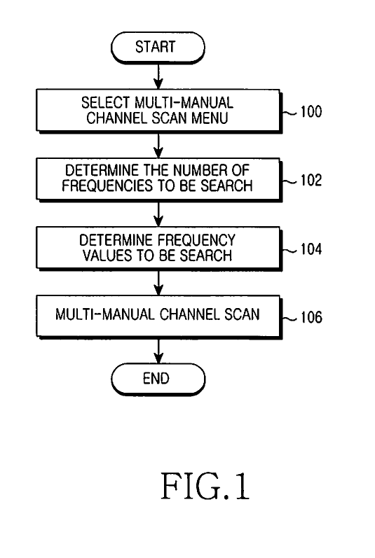

FIG. 1 illustrates a flowchart for selecting a plurality of channels desired by a user and performing channel scanning by a digital broadcast receiver according to an embodiment of the present invention.

Referring to FIG. 1, when a multi-manual channel scan menu is selected by a user in step 100, the digital broadcast receiver determines number of frequencies in step 102, and determines frequency values to be searched in step 104. In step 102. That is, a user provides the digital broadcast receiver with a number of frequencies (e.g., integer 3), and the user inputs the frequency values (e.g., f1(87.7 MHz), f2(89.7 MHz), and f3(91.9 MHz)) into the digital broadcast receiver.

The digital broadcast receiver performs scanning on a plurality of set channels according to a predetermined order in step 106, and stores channel information in an internal memory. When previous channel information exists in the internal memory, the digital broadcast receiver deletes the previous channel information and stores channel information after the performance of the channel scanning.

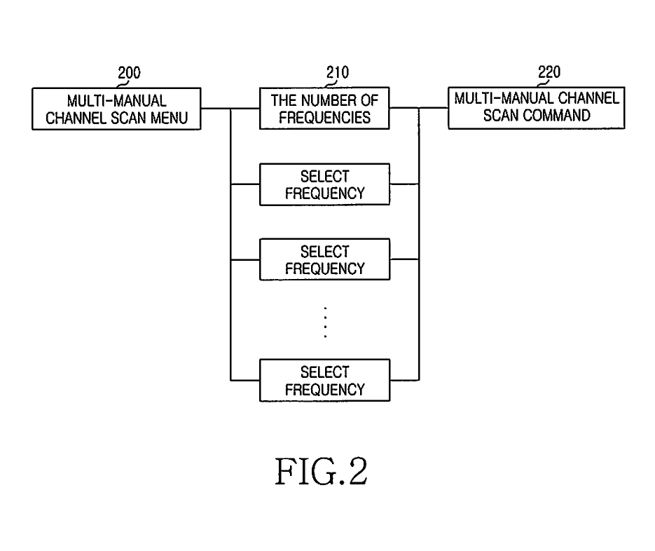

FIG. 2 illustrates a channel scan menu tree in a digital broadcast receiver according to an embodiment of the present invention.

As described above, during a conventional automatic channel scan, a lot time is taken because searching is performed over all frequencies. Further, during a conventional manual channel scan, a user is inconvenienced by having to manually set a frequency in a menu and collect search results for each frequency.

Referring to FIG. 2, according to an embodiment of the present invention, when a multi-manual channel scan menu 200 is selected by a user, only frequencies already known in advance (e.g., broadcast channel information as shown in Table 1 below is provided by a broadcast service provider) are displayed for the user to select for scanning in menu screen 210, instead of scanning all channels which are being broadcast within a range designated in the automatic channel scan. Accordingly, channels that are not being broadcast are not searched for when the multi-manual channel scan command 220 is received. The selected number of channels 210 controls the number of frequencies using a frequency select bar by designating in advance the number of frequencies to be selected. When the available frequencies are not displayed on one page, a scroll bar is generated and selected frequencies may then be viewed in one page. The displaying of the scroll bar to enable frequency selection is similar to designating a frequency in the manual channel scan as in the prior art, however, a menu entry operation of setting a frequency and then collecting results thereof, and then performing a second menu entry operation of setting a different frequency and then collecting results thereof, as performed in the manual channel scan, are incorporated into one operation by simultaneously setting frequencies from the known frequencies determined in a previous operation which is step 210. In step 210, specific frequencies are selected to search from a list of known frequencies. And the number of frequencies (for example, integer 3) is determined in a previous search operation.

According to an embodiment of the present invention, number of frequencies to be selected by a user is not designated, i.e., the user does not input the number of frequencies (for example, integer 3).

When a user selects one frequency, the user may be asked whether they would like to select another frequency. For example, an input window may be displayed, in which the user may select the next frequency, or a window querying whether to perform channel scan on frequencies previously selected may be displayed depending on query results.

According to an embodiment of the present invention, when a user does not know a frequency of a relevant channel, the digital broadcast receiver may display broadcast channel information provided by a broadcast service provider to enable the user to select the frequency of the relevant channel from the broadcast channel information before setting the number of frequencies or setting a frequency.

An example of broadcast channel information is given in Table 1.

| | Channel Name | Frequency | Contents |
|---|---|---|---|
| CH1 | Cinema TV | f1 | movie |
| CH2 | m.net | f2 | Music |
| CH3 | KBS drama | f3 | Drama |
| . . . | . . . | . . . | . . . |

The digital broadcast receiver displays the broadcast channel information of Table 1 to enable a user to select a plurality of channels or frequencies for scanning. When the digital broadcast receiver displays the broadcast channel information, for example, the user may be presented with a check box next to each item of broadcast channel information for enabling the user to select a relevant channel or frequency for scanning of the channel or frequency to be performed.

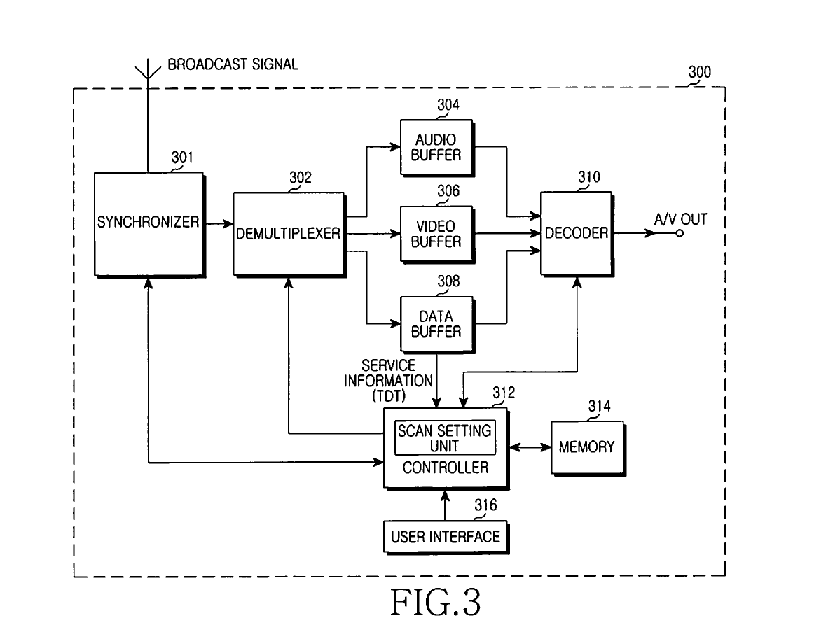

FIG. 3 illustrates a digital broadcast receiver for selecting a plurality of channels desired by a user and performing channel scanning, according to an embodiment of the present invention.

Referring to FIG. 3, the digital broadcast receiver 300 includes a synchronizer 301 for receiving a broadcast signal, a demultiplexer 302 for separating a transmission stream of a broadcast program received via the synchronizer 301 into audio/video/data, an audio buffer 304 for temporarily storing audio output from the demultiplexer 302, a video buffer 306 for temporarily storing video output from the demultiplexer 302, a data buffer 308 for temporarily storing data output from the demultiplexer 302, a decoder 310 for decoding signals of the buffers 304, 306, and 308, and a memory 314 for storing various data and programs necessary for an operation of the digital broadcast receiver 300.

The memory 314 stores an operation program that enables the digital broadcast receiver 310 to perform a channel scan operation, and various data required during an operation of the operation program. For example, the memory 314 stores broadcast channel information (refer to Table 1) provided by a broadcast service provider. The broadcast channel information includes channel information that enables a user to select a channel or a frequency for channel scanning. In addition, the memory 314 stores a frequency value obtained after channel scanning and a channel number associated with the frequency value as channel information. Afterward, the channel information is used to enable the user to view broadcast signals of a requested channel.

In addition, during digital broadcasting received via a broadcast antenna or via cable, the synchronizer 301 tunes an arbitrary broadcast channel desired by the user. For this purpose, when the user selects a desired broadcast channel through a user interface 316, a controller 312 reads information corresponding to the selected broadcast channel from the memory 314 and provides the channel information to the synchronizer 301.

In addition, the controller 312 reads and searches for Service Information (SI) temporarily stored in the data buffer 308 to use the SI as reference information for broadcast signal processing and various controls.

The digital broadcast receiver 300 according to an embodiment of the present invention includes the controller 312 for performing various controls required by the digital broadcast receiver 300, such as reception of a digital broadcast program, recording of an arbitrary broadcast program, reproduction of a broadcast program stored in a hard disk (not shown), etc. In addition, the controller 312 controls a tuning operation of the synchronizer 301 for controlling a channel scan operation. The controller 312 includes a scan setting unit 312 for controlling a channel scan operation. That is, when an automatic channel scan mode is selected via the user interface 316, the scan setting unit 312 controls to search for a channel that is being broadcast from all frequency bands or a frequency band set to a predetermined range. During a manual channel scan mode, the scan setting unit 312 specifies one frequency and searches for a channel. In addition, for a multi-manual channel scan mode, the scan setting unit 312 receives the frequencies selected by the user via the user interface 316, and is provided with relevant frequency information to control a channel scanning operation (refer to the channel scan procedure of FIG. 1).

According to an embodiment of the present invention, the scan setting unit 312 does not designate the number of frequencies to be selected by the user. When one frequency is selected via the user interface 316, the scan setting unit 312 asks the user whether to continue to select a frequency, and displays an input window so that the user may select the next frequency, or displays a window asking whether to perform channel scanning on frequencies selected previously, depending on query results.

According to an embodiment of the present invention, when the user cannot know a frequency of a relevant channel, the scan setting unit 312 controls to display broadcast channel information (refer to Table 1) stored in the memory 314 so that the user may select the frequency of the relevant channel from the broadcast channel information before setting the number of frequencies or setting a frequency.

Although the present invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for searching a channel in a digital broadcast receiver, the method comprising:
determining a number of broadcast channels to be searched;
determining frequency values corresponding to the number of broadcast channels; and
searching broadcast channels based on the determined frequency values.

2. The method of claim 1, further comprising storing the searched broadcast channel information.

3. The method of claim 1, wherein the determining of the frequency values corresponding to the number of broadcast channels comprises one of:
receiving frequency values from a user; and
selecting a channel index mapped to a relevant frequency.

4. A method for scanning a channel in a digital broadcast receiver, the method comprising:
determining a frequency value corresponding to a broadcast channel to be scanned;
displaying the determined frequency value;
asking a user whether to scan another broadcast channel and
scanning the channel based on the determined frequency value, if the user does not determine to scan the another broadcast channel, or based on both the determined frequency value and a frequency value according to the another broadcast channel, if the user determines to scan the another broadcast channel.

5. The method of claim 4, further comprising storing scanned broadcast channel information.

6. The method of claim 4, wherein the determining of the frequency value corresponding to the broadcast channel to be scanned comprises at least one of:
receiving a frequency from a user; and
selecting a channel index mapped to a relevant frequency.

7. The method of claim 4, wherein determining the frequency value corresponding to a broadcast channel to be scanned comprises one of:
displaying, on a display window, a frequency or channel index information corresponding to a plurality of determined broadcast channels; and
displaying one of set one frequency and set one channel index information is displayed on the display window.

8. A method for scanning a channel in a digital broadcast receiver, the method comprising:
displaying a broadcast channel list when a multi-manual channel scan menu is selected;
selecting a frequency corresponding to at least one broadcast channel to be scanned from the displayed broadcast channel list; and
scanning the frequency corresponding to the selected at least one broadcast channel.

9. The method of claim 8, further comprising storing scanned broadcast channel information.

10. The method of claim 8, wherein the broadcast channel list includes frequency information mapped to corresponding channels.

11. An apparatus for scanning a channel in a digital broadcast receiver, the apparatus comprising:
a scan setting unit for determining a number of broadcast channels to be scanned, and determining frequency values corresponding to the broadcast channels; and
a synchronizer for scanning the broadcast channels based on the determined frequency values.

12. The apparatus of claim 11, further comprising a memory unit for storing scanned channel information.

13. The apparatus of claim 11, wherein when determining the frequency corresponding to the broadcast channels, the scan setting unit receives a frequency from a user, or selects a channel index mapped to a relevant frequency.

14. An apparatus for scanning a channel in a digital broadcast receiver, the apparatus comprising:
a scan setting unit for determining at least one frequency to be scanned, and displaying the determined frequency, and querying a user as to whether to scan another broadcast channel; and
a synchronizer for scanning for the frequency corresponding to the broadcast channel, when requested by the user.

15. The apparatus of claim 14, further comprising a memory unit for storing scanned broadcast channel information.

16. The apparatus of claim 14, wherein the scan setting unit receives a frequency from a user, or selects a channel index mapped to a relevant frequency.

17. The apparatus of claim 14, wherein the scan setting unit displays a plurality of set frequencies or channel index information on a display window, or displays set one frequency or set one channel index information on the display window.

18. An apparatus for scanning a channel in a digital broadcast receiver, the apparatus comprising:
a controller for, when a multi-manual channel scan menu is selected, displaying a broadcast channel list;
a scan setting unit for selecting at least one frequency to be scanned from the displayed broadcast channel list; and
a synchronizer for scanning the at least one frequency.

19. The apparatus of claim 18, further comprising a memory unit for storing scanned broadcast channel information.

20. The apparatus of claim 18, wherein the broadcast channel list comprises frequency information mapped to corresponding channels.
